(19) United States
(12) Patent Application Publication
(10) Pub. No.: US 2022/0383282 A1
(43) Pub. Date: Dec. 1, 2022

(54) DIGITAL RIGHTS MANAGEMENT USING DISTRIBUTED LEDGERS

(71) Applicant: Kyodai Technologies Inc., d/b/a/ Rensa Games, Cheyenne, WY (US)

(72) Inventors: Anthony J. Apollo, Cheyenne, WY (US); Frank M. Apollo, Cheyenne, WY (US); Nicholas C. Apollo, Cheyenne, WY (US)

(21) Appl. No.: 17/824,122

(22) Filed: May 25, 2022

Related U.S. Application Data
(60) Provisional application No. 63/195,445, filed on Jun. 1, 2021.

(51) Int. Cl. G06Q 20/12; G06Q 20/36; G06Q 20/38

(52) U.S. Cl. CPC G06Q 20/1235; G06Q 20/36; G06Q 20/127; G06Q 20/389; G06Q 2220/18

(57) ABSTRACT

Systems and methods for managing digital rights associated with digital objects using distributed ledgers are provided. A digital object marketplace receives a request to access a digital object via an interface provided by the digital object marketplace. The marketplace queries the user's digital wallet for a license token generated by a smart contract for the digital object deployed in a distributed ledger. If the user does not have a license token, the marketplace prompts the user to purchase one. If the user submits a request to purchase a license token, a payment is transferred, using the smart contract, from the user's digital wallet to the digital wallet of the owner of the digital object. Further, the license token is added to the user's digital wallet. This enables the user to access the digital object via the interface.

### CROSS-REFERENCE TO RELATED APPLICATIONS

The present patent application claims the priority benefit of U.S. provisional patent application No. 63/195,445 filed Jun. 1, 2021, the disclosure of which are incorporated by reference herein.

### FIELD

The present disclosure relates generally to systems and methods for managing digital rights associated with digital objects using distributed ledgers.

### BACKGROUND

Content publishers, such as large video game developers, often implement digital rights management (DRM) systems to prevent users from pirating their digital objects (e.g., the illicit downloading and sharing of these digital objects), exploiting elements of these digital objects (e.g., cheating, etc.), and the like. However, malicious users often try to circumvent these DRM systems, leading to content publishers implementing additional measures. These additional measures can be onerous to legitimate users of their digital objects. In addition to these issues, the DRM systems implemented by these content publishers can also prevent users from re-selling their access rights to these digital objects to others, limiting the amount of control users have in managing use of their licenses to these digital objects.

### SUMMARY

Disclosed embodiments provide a framework for a distributed ledger-based DRM system that utilizes cryptographically secure tokens to gate access to digital objects or programs. Digital objects published to a digital object marketplace may be accessed in a user's browser application or other application (e.g., standalone application for the digital object marketplace, console application, mobile device application, etc.) integrated with a user's digital wallet via an interface provided by the digital object marketplace. When a user, using such an application, attempts to access a digital object through this interface, the digital object marketplace can determine whether a license token has been issued to the user for the digital object. If the digital object marketplace 67274888.1 determines that a license token has been issued to the user for the digital object, the digital object marketplace may allow the user to access, utilize, and/or interact with the digital object. Alternatively, if the user does not have the required license token, the digital object marketplace can provide the user with an option to purchase a license token that can be added to the user's digital wallet. The user can submit a request to purchase the license token, which can be processed by the digital object marketplace using a smart contract for the digital object deployed to a distributed ledger. The smart contract can issue a license token to the user's digital wallet. Once the license token is added to the digital wallet, the digital object marketplace can update the interface to provide the user access to the digital object.

In some instances, the license token can also be transferred to other users of the digital object marketplace, subject to any applicable transfer restrictions, such as a minimum transfer value, defined by the content creator of the digital object and any applicable policies. Other transfer restrictions may include, but are not limited to, blocking transfers of the license token during a designated period of time following the initial sale. When a license token is transferred to another user, the payment for the license token can be distributed amongst the user and any content creators associated with the digital object, as defined in the smart contract. Once the license token is added to the other user's digital wallet, the other user can access the digital object via the interface. Further, access to the digital object is revoked for the user that sold its license token, as this user may no longer have the license token in its digital wallet.

According to some embodiments, a computer-implemented method is provided. The computer-implemented method comprises receiving a request to access a digital object. The digital object is made accessible via a remote interface. The computer-implemented method further includes querying a first digital wallet for a license token. The license token grants access to the digital object via the remote interface. Further, the first digital wallet is associated with a distributed ledger. License tokens for the digital object are generated by a smart contract deployed in the distributed ledger. The computer-implemented method further includes prompting a user associated with the first digital wallet to purchase the license token. The user is prompted as a result of a determination that the first digital wallet does not include the license token. The computer-implemented method further includes receiving a request to purchase the license token. The computer-implemented method further includes transferring a payment from the first digital wallet to a second digital wallet associated with an owner of the digital object. The payment is transferred by the smart contract and the payment is recorded in the distributed ledger. The computer-implemented method further includes providing the license token to the first digital wallet. Further, the computer-implemented method includes granting access to the digital object via the remote interface. Access to the digital object is granted as a result of the first digital wallet holding the license token.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

The present disclosure is described in conjunction with the appended Figures:

FIG. 1 shows an illustrative example of an environment in which various embodiments can be implemented;

FIG. 2 shows an illustrative example of an environment in which digital objects published to a digital object marketplace are accessible subject to corresponding license tokens generated using smart contracts deployed to a decentralized distributed ledger in accordance with at least one embodiment;

FIG. 3 shows an illustrative example of an environment in which a smart contract is used to issue license tokens to licensees to enable access to a digital object and to issue corresponding payments to content creators in accordance with at least one embodiment;

FIGS. 4A-4C show an illustrative example of a browser application through which a user can access a digital object via a digital object marketplace upon purchase of a license token for the digital object in accordance with at least one embodiment;

FIG. 5 shows an illustrative example of a process for validating a license token for a digital object to determine whether to grant access to the digital object via the digital object marketplace in accordance with at least one embodiment;

FIG. 6 shows an illustrative example of a process for transferring a license token for a digital object from a first digital wallet to a second digital wallet in accordance with at least one embodiment; and

FIG. 7 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

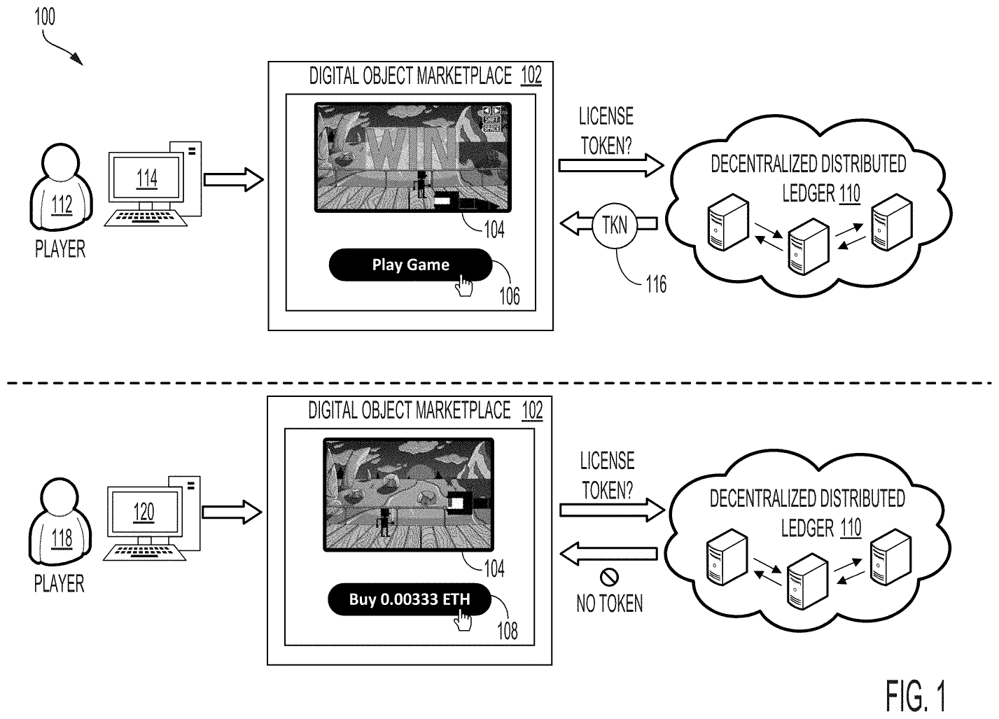

FIG. 1 shows an illustrative example of an environment 100 in which various embodiments can be implemented. In the environment 100, a user (such as player 112), using a computing device 114 (e.g., desktop computer, laptop computer, tablet computer, smartphone, etc.) may submit a request to a digital object marketplace 102 to access a digital object for which the user has obtained a license token authorizing the user to access the digital object via an interface 104 provided by the digital object marketplace 102. The digital object marketplace 102 may be an open peer-to-peer (P2P) digital exchange, through which independent content creators may list and monetize their digital objects via license tokens. Licensees may purchase a license token 116 for a digital object from the digital object marketplace 102 and, accordingly, leverage this digital object to develop new digital media in a collaborative manner. The digital object marketplace 102 may be implemented as a digital platform, utilizing computer systems and applications as a backend to manage digital objects on behalf of content creators, furnish owner tokens to content creators upon digital object upload (and/or implement alternative methods of tracking and executing financial distributions, such as designating recipient wallet addresses described in greater detail herein), furnish license tokens to licensees upon purchase, and distributing corresponding payments to content creators automatically and in real-time using a decentralized distributed ledger 110.

In an embodiment, through the digital object marketplace 102, a content creator can upload a digital object and define one or more parameters for making the digital object available to licensees, such as player 112. For instance, a content creator may define a price for purchasing a license token 116 that may denote a licensee's authorization to utilize the digital object via the digital object marketplace 102. For instance, a licensee being provided with a license token 116 to a particular digital object published to the digital object marketplace 102 may access the digital object via the digital object marketplace 102 and utilize the digital object for its own projects, subject to any policies defined by the content creator. As an illustrative example, a content creator may seek to publish a set of digital animations that it has recorded for various fight scenes. A licensee, in turn, may need such digital animations for a new video game that it is developing. Thus, the licensee may access the digital object marketplace 102 to request a license token 116 to the digital animations published by the content creator.

In an embodiment, the digital object marketplace 102 can require each user to link a digital wallet to the digital object marketplace 102. The digital wallet may be required for the management of license tokens, processing of payments for license tokens, and to receive automated payments associated with the purchase of license tokens by licensees and with financial distributions (e.g., revenue shares, royalties, etc.) earned as a result of the sale of license tokens corresponding to digital media that includes digital objects subject to pre-defined financial distribution terms. In an embodiment, the digital wallet is a software-based cryptocurrency wallet that is used to interact with a decentralized distributed ledger 110. The digital wallet may be made accessible via a browser extension application executed when a user accesses a corresponding browser application on their computing device. In an embodiment, when a user (e.g., player 112, etc.) accesses the digital object marketplace 102 utilizing its browser application, the digital object marketplace 102 may attempt to access the browser extension application for authentication of the user and to link the user's account within the digital object marketplace 102 with its digital wallet. In some instances, if the user is utilizing a standalone application associated with the digital object marketplace 102, access to the digital wallet may be integrated therein, whereby the user may provide a set of credentials to access its digital wallet via the application.

It should be noted that while browser extension applications are described extensively throughout the present disclosure for the purpose of illustration, a user's digital wallet may be implemented using a hardware wallet, such as the Ledger® Nano S. A hardware wallet may store a user's private cryptographic keys on a secure hardware device. Thus, the hardware wallet may provide a level of isolation between the user's cryptographic keys and their other computing devices. The hardware wallet may be used in conjunction with a software application companion, which may provide a bridge between the hardware wallet and the digital object marketplace, allowing the digital object marketplace to interact with the hardware wallet to authenticate the user and to link the user's account with the hardware wallet. This link may facilitate the transactions described and contemplated herein.

The decentralized distributed ledger 110 may be a decentralized database managed by various members across multiple nodes. This decentralized database may be shared, replicated, and synchronized amongst these various members within a decentralized network. These members within the decentralized network may govern and agree by consensus on updates to the records in the distributed ledger 110. The decentralized distributed ledger 110 is, thus, decentralized by virtue of having no central authority or mediator involved in the governance of the distributed ledger. Each record that is maintained in the decentralized distributed ledger 110 may have a timestamp and unique cryptographic signature, which may be used to audit the distributed ledger 110 and to provide a comprehensive history of transactions within the decentralized network. As contemplated herein, any type of decentralized distributed ledger 110 may be used that supports the creation and implementation of smart contracts and for the recording of transactions and distribution of payments amongst users of the digital object marketplace 102. Thus, the decentralized distributed ledger 110 may include a public or private blockchain, Hashgraph, Directed Acyclic Graph (DAG), Holochain, Radix Tempo, and the like.

In an embodiment, each digital object published to the digital object marketplace 102 is associated with a smart contract deployed to the decentralized distributed ledger 110. For instance, when a contract creator defines a purchase price for a license token 116 for a digital object that is to be published to the digital object marketplace 102, any applicable transfer restrictions for the digital object, and any applicable financial distribution terms, the digital object marketplace 102 may map the purchase price, the applicable transfer restrictions, and any applicable financial distribution terms to a smart contract or token. A smart contract may be a collection of programmatic code and data that may reside at a specific address on the decentralized distributed ledger 110. The smart contract may serve as a type of account within the decentralized distributed ledger 110, whereby the smart contract may have a balance and may transmit transactions over the decentralized network. The smart contract may be deployed to the decentralized network of the decentralized distributed ledger 110 and may function as programmed by the digital object marketplace 102. The digital object marketplace 102 may interact with the smart contract by submitting transactions on behalf of users that execute one or more functions defined in the smart contract. This may include distributing license tokens to users (such as license token 116 to player 112), distributing payment to the owner of the digital object associated with the smart contract, and the like.

In an embodiment, the digital object marketplace 102 deploys a platform smart contract to the decentralized distributed ledger 110 that can generate, or mint, owner tokens and license tokens for each digital object published to the digital object marketplace 102. For instance, the platform smart contract may distribute owner tokens and license tokens to users of the digital object marketplace 102 for each digital object published to the digital object marketplace 102. Each token may have a unique identifier (e.g., a unique unsigned integer, etc.) and any payments resulting from license purchases and/or financial distribution terms for digital objects published to the digital object marketplace 102 can be processed by the platform smart contract according to token metadata or a distribution contract.

A distribution contract may define a one-to-one relationship between each object owner token and the financial distribution terms for each contributor associated with the digital object. The object owner token, in an embodiment, stores the addresses of the digital wallets associated with the contributors associated with the object owner token. In some instances, a contributor may be any entity that contributed to the creation of the underlying digital object, including other digital objects, other media, or computer code that may be compiled to form the digital object. In an embodiment, when a payment is transmitted to the distribution contract, each contributor associated with the distribution contract may automatically receive a portion of the payment according to the previously defined financial distribution terms.

When the smart contract corresponding to the published digital object is deployed to the decentralized distributed ledger 110, the smart contract may generate an object owner token that designates the content creator as the originator of the digital object. The object owner token may be issued and held by the content creator in its digital wallet and recorded in the decentralized distributed ledger 110. In an embodiment, the object owner token is transferrable to other users of the digital object marketplace 102. For instance, a content creator can sell the object owner token to another user at an agreed upon price. The transaction may be processed using the decentralized distributed ledger 110 and recorded therein. The other user, now the holder of the object owner token, may automatically, and in real-time, receive any payments generated through the sale of license tokens associated with the digital object and any financial distributions generated by the license tokens linked to the object owner token. Further, the original owner of the object owner token may no longer receive any payments generated through the sale of license tokens associated with the digital object and any financial distributions generated by the license tokens linked to the object owner token, as this original owner is no longer the holder of the object owner token.

In an embodiment, the smart contract corresponding to the published digital object is a distribution contract (as described above) that designates a specific digital wallet address (e.g., a recipient digital wallet) as the recipient of any payments generated through the sale of tokenized licenses associated with the digital object and any financial distributions generated by the tokenized licenses associated with the published digital object. The smart contract, in some instances, may be modified to designate a different recipient digital wallet. This modification to the smart contract may have a similar effect to that resulting from the transfer of the aforementioned object token to another user, whereby the newly designated recipient digital wallet may automatically, and in real-time, receive any payments generated through the sale of tokenized licenses and any financial distributions generated by these tokenized licenses.

In addition to generating an object owner token or designating a recipient digital wallet, the smart contract may also generate the aforementioned license tokens (also referred to herein as “object license tokens”) for the digital object. The object license tokens may be generated automatically when the smart contract is deployed to the decentralized distributed ledger 110 and provided to the digital wallet owned and maintained by the digital object marketplace 102 on behalf of the content creator. When a licensee (e.g., player 112) purchases a license to the digital object via the digital object marketplace 102, the digital object marketplace 102 may automatically transfer an object license token 116 from its digital wallet to the digital wallet of the licensee. This transaction may be recorded in the decentralized distributed ledger 110. In an embodiment, an object license token 116 can be generated at the point-of-sale (e.g., when the licensee submits a request to purchase a license to the digital object) by the smart contract and automatically transferred to the licensee's digital wallet.

As illustrated in FIG. 1, when player 112, through its computing device 114, attempts to access the digital object from a landing page of the digital object marketplace 102 corresponding to the digital object, the digital object marketplace 102 may determine whether the player 112 has a license token 116 in its digital wallet corresponding to the digital object. For instance, when the player 112 accesses the landing page for the digital object, the digital object marketplace 102 may dynamically and in real-time access the player's digital wallet from the decentralized distributed ledger 110 to determine whether a license token 116 corresponding to the digital object has been issued to the player 112. If the digital object marketplace 102 determines that a license token 116 has been issued to the player's 112 digital wallet, the digital object marketplace 102 may determine whether this license token 116 is valid (e.g., not expired, grants the player 112 access to the digital object, etc.). If the license token 116 in the player's digital wallet is valid, the digital object marketplace 102 may present, via the landing page for the digital object, an access option 106. The access option 106 may include an interactive element, such as a graphical user interface (GUI) button that, if selected, may allow the player 112 to access the digital object via an interface 104 provided by the digital object marketplace 102.

The interface 104 for the digital object may be executed within the player's browser application through an inline frame (e.g., iFrame) used to launch a media player through which the digital object may be accessed and utilized. The digital object may alternatively be executed within the player's browser application through an executable program, such as a JavaScript program using HTML, technologies and rendering application programming interfaces (APIs), to execute the digital object within the browser application (e.g., glTF, WebGL, etc.). In some instances, the interface 104 for the digital object may be executed through an external client (e.g., a client outside of a browser application, etc.). In an embodiment, if the digital object marketplace 102 determines that the player 112 has a valid license token 116 for the digital object, the digital object marketplace 102 can allow the player 112 to execute the interface 104 through which the player 112 may access the digital object subject to the authorizations provided via the license token 116.

In an embodiment, the license token 116 issued to the player 112 can be transferrable to other users of the digital object marketplace 102. For instance, the player 112 may sell its license token 116 to another user at an agreed upon price, subject to the one or more transfer restrictions set by the content creator of the digital object, as defined in the smart contract for the digital object. For instance, the one or more transfer restrictions may include a minimum transfer value, which may create a floor value for re-sales of a license token 116 for the digital object in order to preserve the revenues for all parties in the value chain (e.g., if the digital object incorporates other digital objects subject to financial distribution terms for the other digital objects) and to prevent piracy by creating an implicit cost to transfer the license token 116.

In an embodiment, the player 112 can make its license token 116 available for sale through the digital object marketplace 102 to other users of the digital object marketplace 102. For example, through the digital object marketplace 102, the player 112 can list for sale its license token 116 on the landing page for the digital object. This may allow other users to readily see, through the landing page, that the license token 116 is available for purchase at a price set by the player 112. In some instances, the player 112 can make the license token 116 available for sale directly via the decentralized distributed ledger 110 through a P2P exchange. The license token 116 may also be made available to other users via a third-party marketplace for the sale of cryptographic objects, such as OpenSea. Since the license token 116 may be directly associated with the smart contract for the digital object, the sale of the license token 116 to other users may be evaluated using the smart contract deployed by the distributed ledger 110.

If a player 118 that does not have a license token for the digital object accesses, via its computing device 120, the landing page provided by the digital object marketplace 102 for the digital object, the digital object marketplace 102 may present, via the landing page for the digital object, a purchase option 108. The purchase option 108 may include an interactive element, such as GUI button that, if selected, may allow the player 118 to submit a request to the digital object marketplace 102 to purchase a license token for the digital object. The price presented within the purchase option 108 may correspond to the purchase price defined by the content creator and mapped to the smart contract for the digital object. When the player 118 purchases a license to the digital object via the digital object marketplace 102, the digital object marketplace 102 may automatically transfer an object license token from its digital wallet to the digital wallet of the player 118. This transaction may be recorded in the decentralized distributed ledger 110. In an embodiment, an object license token can be generated at the point-of-sale (e.g., when the player 118 submits a request to purchase a license to the digital object) by the smart contract and automatically transferred to the player's digital wallet. The payment submitted by the player 118 may be transferred from the player's digital wallet to the content creator and any other content creators that may be entitled to financial distributions subject to a distribution schema defined in the smart contract.

In an embodiment, when a license token is transferred to the player's digital wallet, the digital object marketplace 102 can automatically, and in real-time, update the landing page to present the aforementioned access option 106. This may allow the player 118 to execute the interface 104 through which the player 118 may access the digital object subject to the authorizations provided via the license token issued to the player 118 upon purchase of the license token. If the license token was purchased from another user (e.g., such as player 112), the license token may be transferred from the other user's digital wallet to the player's 118 digital wallet. The other user, no longer the holder of the license token, may no longer have access to the digital object.

In an embodiment, the digital object marketplace 102 can retain the ability to perform various actions related to the control of license tokens for a digital object. For instance, the digital object marketplace 102 may retain the ability to freeze existing license tokens (e.g., prevent a license token to be used to access a digital object for a period of time), burn existing license tokens (e.g., remove or destroy a license token from a user's digital wallet), and/or re-issue license tokens. For instance, if a player transmits a license token to an incorrect address, the digital object marketplace 102 can automatically destroy the license token from the incorrect recipient's digital wallet and re-issue a license token to the intended recipient's digital wallet. In some instances, retaining the ability to perform these actions may be required for regulatory compliance.

In an embodiment, the digital object marketplace 102 can maintain a database of authorized digital wallet addresses corresponding to users that may utilize the digital object marketplace 102 and transact with other users via the digital object marketplace 102. For instance, each user of the digital object marketplace 102 may be required to participate in an onboarding process through which the user may be vetted by the digital object marketplace 102 (e.g., determine that the user is not a malicious or suspicious user, etc.). As part of the onboarding process, the user may be required to link a digital wallet to the digital object marketplace 102. As noted above, the digital wallet may be required for the management of license tokens, processing of payments for license tokens, and to receive automated payments associated with the purchase of license tokens by licensees and with financial distributions earned as a result of the sale of license tokens corresponding to digital media that includes digital objects subject to pre-defined financial distribution terms. The cryptographic address for the digital wallet may be added to the database of authorized digital wallet addresses. Thus, when a user attempts to purchase a license token or to sell a license token to another user, the digital object marketplace 102 may dynamically, and in real-time, determine whether the users involved have corresponding digital wallets that have been vetted by the digital object marketplace 102. If any user has not been vetted by the digital object marketplace 102, the transaction may be denied.

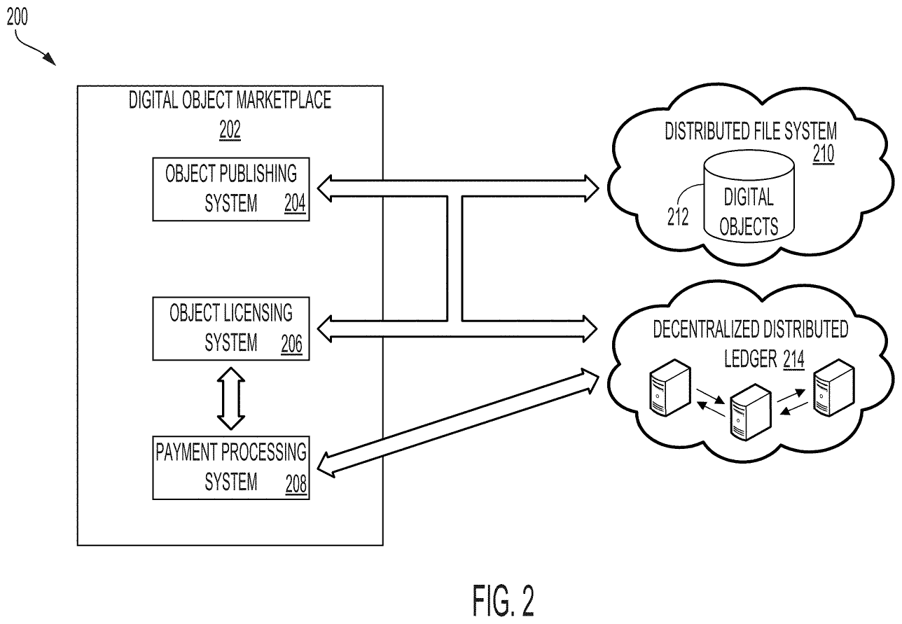

FIG. 2 shows an illustrative example of an environment 200 in which digital objects published to a digital object marketplace 202 are accessible subject to corresponding license tokens generated using smart contracts deployed to a decentralized distributed ledger 214 in accordance with at least one embodiment. In the environment 200, the digital object marketplace 202 includes an object publishing system 204, which may allow users of the digital object marketplace 202, such as content creators and independent developers, to publish their digital objects to the digital object marketplace 202. The object publishing system 204 may be implemented using a computer system of the digital object marketplace 202 or as an application or code executing on one or more computer systems of the digital object marketplace 202.

In an embodiment, the digital object marketplace 202, through the object publishing system 204, provides users with an interface and platform through which users can publish their digital objects. For instance, a content creator or independent developer can utilize the object publishing system 204 to upload a digital object and define one or more parameters (e.g., purchase price, financial distribution terms, one or more transfer restrictions for license tokens associated with the digital object, terms or policies for use of the digital object, number of license tokens to be made available, any price bonding curves, etc.) for making the digital object available to purchasers via the digital object marketplace 202. For instance, a content creator or independent developer may define a price for purchasing an object licensing token that may denote a purchaser's authorization to utilize the digital object. For instance, a purchaser of an object license token for a particular digital object published to the digital object marketplace 202 may access the digital object via the digital object marketplace 202 and utilize the digital object for its own projects, subject to any policies defined by the content creator or independent developer.

Once a content creator or independent developer has published a digital object to the object publishing system 204 and has provided corresponding licensing parameters for the digital object, the object publishing system 204 may store the digital object in a digital object store 212 of a distributed file system 210. The distributed file system 210 may rely on cryptographic hashes that can be stored in a distributed ledger, such as decentralized distributed ledger 214. The distributed file system 210 may utilize content-addressing to uniquely identify each digital object stored in the digital object store 212 using a global namespace connecting various devices within the decentralized network. Similar to the decentralized distributed ledger 214, the distributed file system 210 may be implemented using a decentralized network of operators that may maintain portions of the overall data. A user of the distributed file system 210 may serve a digital object by its corresponding content address, allowing other users in the network to find and request the digital object from any node that maintains the digital object using a distributed hash table. Examples of distributed file systems include InterPlanetary File System (IPFS), Arweave, Storj, Filecoin, Sun Microsystems® Network File System (NFS), Microsoft® Distributed File System, IBM® Distributed File Service (DFS), Amazon® Simple Storage Service (S3), and the like.

In addition to storing the digital object using the distributed file system 210, the object publishing system 204 may map the purchase price, any applicable licensing terms, and financial distribution terms to a smart contract or owner or license token metadata corresponding to the digital object. The smart contract, as noted above, may be deployed to the decentralized distributed ledger 214, where the smart contract may reside at a specific address on the decentralized distributed ledger 214. The smart contract may serve as a type of account within the decentralized distributed ledger 214, whereby the smart contract may have a balance and may transmit transactions over a decentralized network. Further, the smart contract may function as programmed by the object publishing system 204. For instance, when users interact with an object licensing system 206 to obtain an object license token for the digital object, as described in greater detail herein, the object licensing system 206 may interact with the smart contract by submitting transactions on behalf of users that execute one or more functions defined in the smart contract.

When the smart contract corresponding to the published digital object is deployed to the decentralized distributed ledger 214, the smart contract may generate an object owner token that designates the content creator or independent developer as the originator of the digital object. The object owner token may be issued and held by the content creator or independent developer in its digital wallet and recorded in the decentralized distributed ledger 214. As noted above, the object owner token may be transferrable to other users of the digital object marketplace 202. Transfers of the object owner token may be processed using the decentralized distributed ledger 214 and recorded therein. The other user, now the holder of the object owner token, may automatically, and in real-time, receive any payments generated through the sale of tokenized licenses associated with the digital object and any financial distributions generated by the object license tokens linked to the object owner token. Further, the original holder of the object owner token may no longer be entitled to any financial distributions associated with the digital object after the transfer of the object owner token to the other user.

As noted above, the smart contract corresponding to the published digital object may be a distribution contract that designates a recipient digital wallet as the recipient of any payments garnered through the sale of tokenized licenses associated with the digital object and any financial distributions generated by the tokenized licenses associated with the published digital object. The smart contract may be modified or updated to designate a different recipient digital wallet. For example, the owner of the digital object may transfer their rights to the digital object to another entity by updating the smart contract to designate the other entity's digital wallet as the recipient digital wallet. This update to the smart contract may result in the other entity, through their digital wallet, receiving any payments generated through the sale of tokenized licenses and any financial distributions generated by these tokenized licenses automatically and in real-time. The original owner, whose digital wallet is no longer referred to in the smart contract, may no longer be entitled to any financial distributions associated with the digital object after the update.

The smart contract deployed to the decentralized distributed ledger 214 may further generate one or more object license tokens that may be made available for licensing of the digital object. The object license tokens may be generated automatically when the smart contract is deployed to the decentralized distributed ledger 214 and provided to a digital wallet owned and maintained by an object licensing system 206 of the digital object marketplace 202 on behalf of the content creator or independent developer (e.g., holder of the object owner token, owner of the recipient digital wallet designated in the smart contract, etc.). The object licensing system 206 may be implemented using a computer system of the digital object marketplace 202 or as an application or code executing on one or more computer systems of the digital object marketplace 202. The object licensing system 206 may provide users with an interface and platform through which users can submit requests to purchase a digital object from the digital object marketplace 202. For instance, through the interface, a user may identify any available digital objects for purchase and submit requests to purchase a license for any of these available digital objects.

In an embodiment, when a user accesses the object licensing system 206 and submits a request to purchase a license to a digital object, the object licensing system 206 may automatically transfer an object license token from its digital wallet to the digital wallet of the user. This transaction may be recorded in the decentralized distributed ledger 214. In an embodiment, an object license token can be generated at the point-of-sale (e.g., when the user submits a request to purchase a license to the digital object through the interface provided by the object licensing system 206) by the smart contract and automatically transferred to the user's digital wallet in real-time.

In an embodiment, when a user submits a request to the object licensing system 206 to purchase an object license token for a digital object, the object licensing system 206 may transmit a payment request to a payment processing system 208 of the digital object marketplace 202 for processing and distribution of the user's payment to the content creator of independent contractor according to the terms specified in the smart contract. The payment processing system 208 may be implemented using a computer system of the digital object marketplace 202 or as an application or code executing on one or more computer systems of the digital object marketplace 202. In some instances, the payment processing system 208 may be implemented by a third-party provider, including third-party payment processing services that may process fiat currency and cryptocurrency payment transactions. The payment processing system 208 may transmit the transaction request, the object owner token held by the content creator or independent developer or the address of the designated digital wallet specified in the smart contract, and an identity token corresponding to the purchaser's digital wallet to the smart contract for the digital object deployed in the decentralized distributed ledger 214 for processing of the transaction. The smart contract, in response, may transfer the payment to the content creator's or independent developer's digital wallet from the purchaser's digital wallet and record the transaction in the decentralized distributed ledger 214. Further, the smart contract may transfer an object license token to the purchaser's digital wallet.

When a user accesses a landing page provided by the digital object marketplace 202 for a particular digital object, the object licensing system 206 may, in real-time, determine whether a license token has been issued to the user for the digital object. For instance, the object licensing system 206 may query the user's digital wallet to determine whether the user has been issued a license token required to access the digital object. If the object licensing system 206 determines that the user does not have the required license token for accessing the digital object, the object licensing system 206 may prompt the user to purchase a license token at a specified price (as set by the content creator or independent developer). However, if the object licensing system 206 determines that the user has the requisite license token for the digital object, the object licensing system 206 may allow the user to access the digital object according to any access control defined in the license token via an interface provided by the digital object marketplace 202.

As noted above, a license token for a digital object may be transferrable to other users of the digital object marketplace 202. For instance, a user may sell its license token associated with a particular digital object to another user at an agreed upon price, subject to one or more transfer restrictions for the digital object. The license token for the digital object may be made available for transfer via the digital object marketplace 202. For instance, through the digital object marketplace 202, a user can list for sale its license token on the landing page for the digital object. This may allow other users to readily see, through the landing page, that the license token is available for purchase at a price set by the original owner. In some instances, the user can make the license token available for sale directly via the decentralized distributed ledger 214 through a P2P exchange. The license token may also be made available to other users via a third-party marketplace for the sale of cryptographic objects.

If the license token is sold via the digital object marketplace 202, the transaction may be processed by the object licensing system 206 using the decentralized distributed ledger 214 and recorded therein. The other user, now the holder of the license token, may automatically, and in real-time, access the digital object via the landing page provided by the digital object marketplace 202 for the digital object. Similarly, if the license token is sold directly via the decentralized distributed ledger 214 or via a third-party marketplace, the transaction may be recorded in the decentralized distributed ledger 214, whereby the transfer of the license token to the purchaser's digital wallet may be memorialized.

In an embodiment, the object licensing system 206 can further control any issued license tokens for the myriad digital objects published to the digital object marketplace 202. For instance, the object licensing system 206 can automatically freeze a license token for a digital object in response to a request from a content creator of the digital object or automatically in response to detection of unusual activity related to the license token. As another example, the object licensing system 206 can burn an existing license token for a digital object. For instance, if a user transfers its license token for a digital object to an incorrect recipient (e.g., transfer is made to the wrong digital wallet address), the object licensing system 206 can automatically burn the license token and re-issue a license token to the intended recipient's digital wallet.

In an embodiment, the object licensing system 206 further maintains a database of authorized digital wallet addresses corresponding to users of the digital object marketplace 202. As noted above, each user of the digital object marketplace 202 may be required to undergo an onboarding process, through which each user may be vetted by the digital object marketplace 202 before being granted access to the digital object marketplace 202 (e.g., to publish digital objects, to purchase license tokens to digital objects, to transfer owner and/or license tokens to other users, etc.). As part of the onboarding process, the user may be required to link a digital wallet to the digital object marketplace 202 via the object licensing system 206. As noted above, a digital wallet may be required for the management of license tokens, processing of payments for license tokens, and to receive automated payments associated with the purchase of license tokens by licensees and with financial distributions earned as a result of the sale of license tokens corresponding to digital media that includes digital objects subject to pre-defined financial distribution terms. The cryptographic address for the digital wallet may be added to the database of authorized digital wallet addresses. Thus, when a user attempts to purchase a license token or to sell a license token to another user, the object licensing system 206 may dynamically, and in real-time, determine whether the users involved have corresponding digital wallets that have been vetted by the digital object marketplace 202.

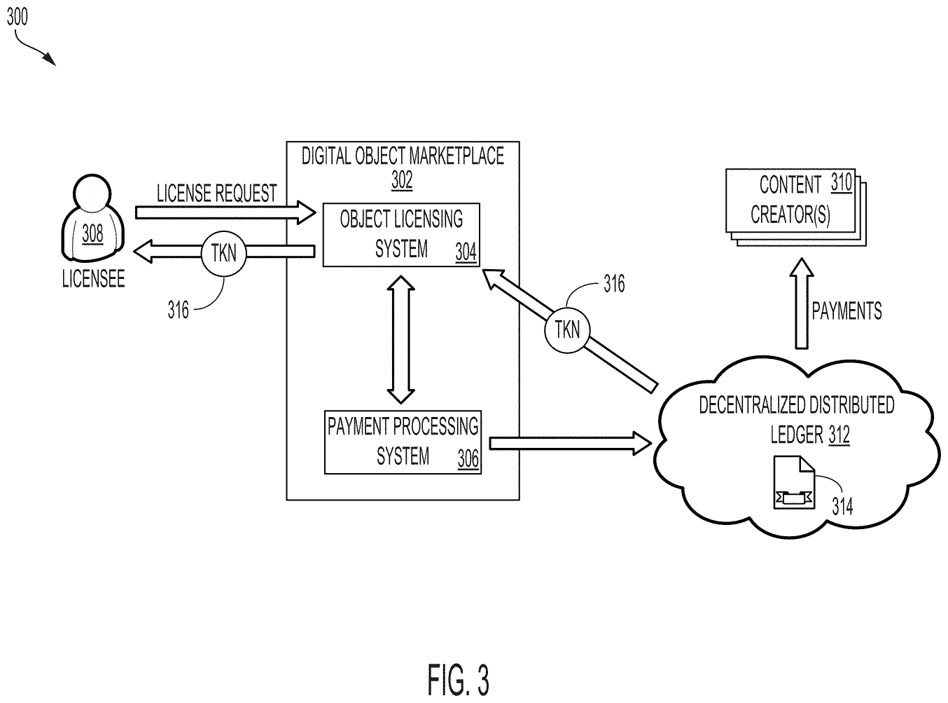

FIG. 3 shows an illustrative example of an environment 300 in which a smart contract 314 is used to issue license tokens 316 to licensees 308 to enable access to a digital object and to issue corresponding payments to content creators 310 in accordance with at least one embodiment. In the environment 300, a licensee 308 may submit a license request to an object licensing system 304 of the digital object marketplace 302 to obtain an object license token 316 for a particular digital object. The object licensing system 304 may be similar to the object licensing system 206 described above in connection with FIG. 2. The license request submitted by the licensee 308 may be subject to an agreed-upon purchase price indicated by the object licensing system 304 via an interface provided by the object licensing system 304. As noted above, the object licensing system 304 may provide users with an interface and platform through which users can submit requests to purchase a digital object from the digital object marketplace 302. For instance, through the interface, a user may identify any available digital objects for purchase and submit requests to purchase a license for any of these available digital objects.

In response to the request from the licensee 308 to purchase an object license token 316 for a corresponding digital object, the object licensing system 304 may provide, to the payment processing system 306, a payment request for processing and distribution of the licensee's payment to a content creator 310 or other holder of an object owner token, or to a designated recipient digital wallet (as indicated in the smart contract corresponding to the digital object), for the digital object. The payment processing system 306, based on an identifier corresponding to the content creator 310 or other holder of an object owner token provided by the object licensing system 304, may access the digital wallet of the content creator or other holder of the object owner token to obtain the object owner token. Alternatively, if the smart contract associated with the digital object indicates an address of a recipient digital wallet to which financial distributions may be deposited, the payment processing system 306 may obtain the address of the recipient digital wallet. Further, the payment processing system 306 may access the licensee's digital wallet to obtain an identity token corresponding to the licensee 308. The payment transaction system 306 may provide the object owner token or designated recipient digital wallet address, the licensee's identity token, and the transaction request to the smart contract 314 deployed to the decentralized distributed ledger 312.

In response to the transaction request, the smart contract 314 may transfer the corresponding payment from the licensee's digital wallet to a digital wallet corresponding to the content creator 310, or other holder of the object owner token, or to the digital wallet designated as the recipient digital wallet in the smart contract. This payment transfer may be recorded by the smart contract 314 into the decentralized distributed ledger 312. Additionally, the smart contract 314 may generate, or mint, an object license token 316 that may be issued to the licensee 308. The smart contract 314 may provide the object license token 316 to the object licensing system 304 which, in turn, may add the object license token 316 to the licensee's digital wallet. In some instances, rather than providing the object license token 316 to the object licensing system 304, the smart contract 314 may automatically add the object license token 316 to the licensee's digital wallet.

In an embodiment, as opposed to minting a new object license token 316 in response to a transaction request, the smart contract 314 for the digital object can generate one or more object license tokens that may be made available for licensing of the digital object. These object license tokens may be generated automatically when the smart contract 314 is deployed to the decentralized distributed ledger 312 and provided to a digital wallet owned and maintained by an object licensing system 304 of the digital object marketplace 302 on behalf of the content creator 310 or independent developer (e.g., holder of the object owner token, owner of the digital wallet designated as the recipient digital wallet in the smart contract, etc.). Once the payment transaction has been completed (e.g., payment has been transferred to the digital wallet of the holder of the object owner token or to the digital wallet designated as the recipient digital wallet in the smart contract), the smart contract 314 may transmit a notification to the object licensing system 304 indicating that the payment from the licensee 308 has been processed. This may cause the object licensing system 304 to transfer an object license token 316 from its digital wallet to the licensee's digital wallet, fulfilling the license request.

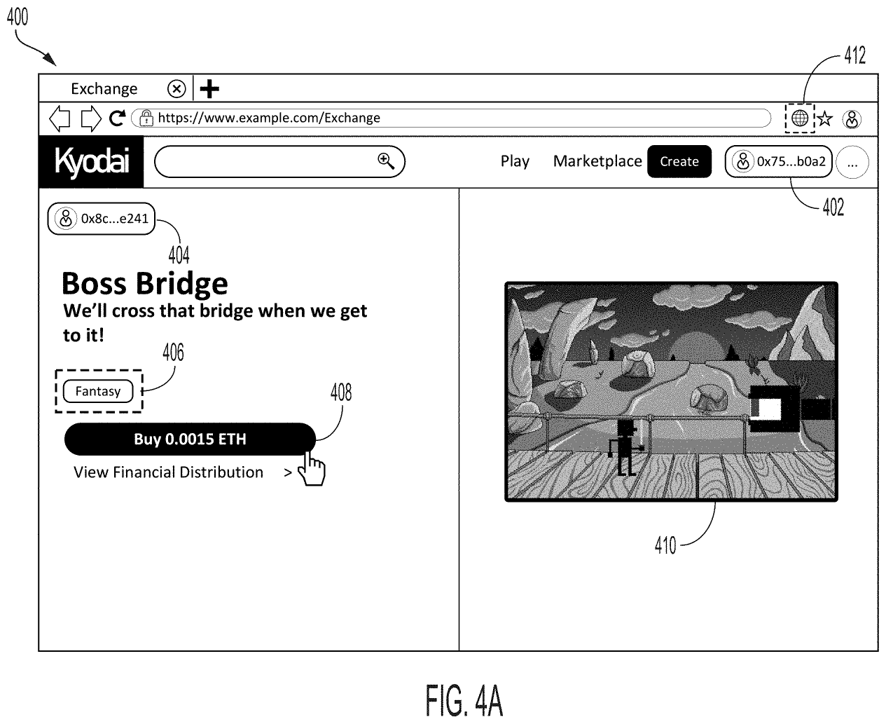

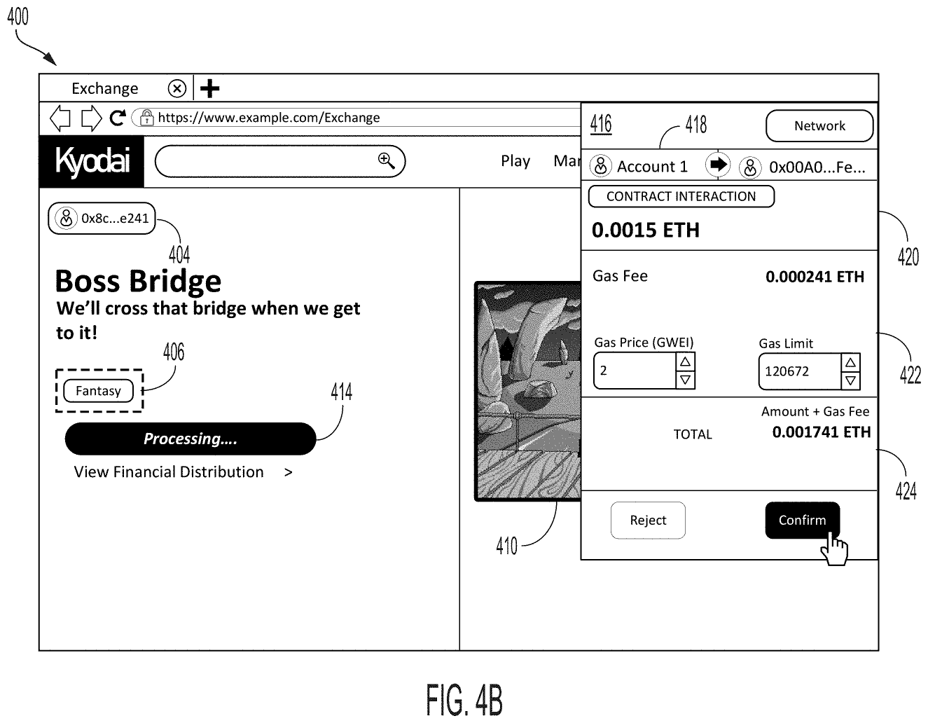

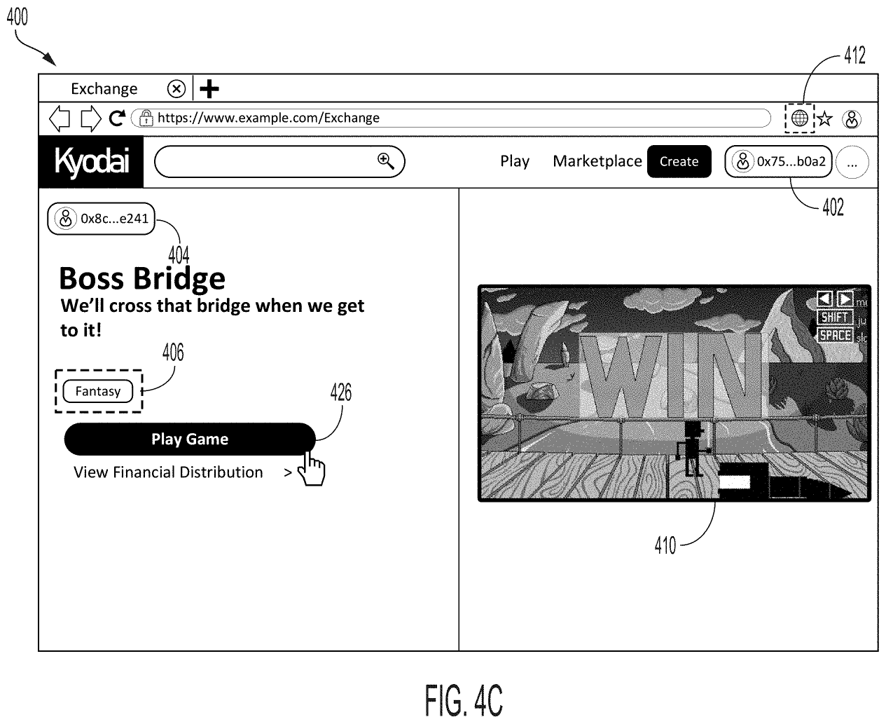

FIGS. 4A-4C show an illustrative example of a browser application 400 through which a user can access a digital object via a digital object marketplace upon purchase of a license token for the digital object in accordance with at least one embodiment. As noted above, the digital object marketplace may provide an interface, such as through a website or web portal, through which users may access a digital object published to the digital object marketplace. As illustrated in FIG. 4A, a user of the digital object marketplace may access a landing page for a particular digital object that may be accessed via an interface 410 provided by the digital object marketplace. The interface 410 may include an inline frame used to launch a media player through which the digital object may be accessed and utilized. The digital object may alternatively be executed within the interface 410 through an executable program, such as a JavaScript program using HTML technologies and rendering APIs, to execute the digital object within the browser application 400. In some instances, the digital object may be executed or presented through an external client (e.g., a client outside of a browser application, etc.).

The landing page may provide various details corresponding to the digital object. For example, the landing page may specify a descriptive title and description of the digital object. Further, the landing page may provide an identifier 404 corresponding to the holder of the object owner token for the digital object or to the owner of the recipient digital wallet designated in the smart contract associated with the digital object. As noted above, when a digital object is published to the digital object marketplace, a smart contract corresponding to the digital object may be deployed to a decentralized distributed ledger. This smart contract may issue an object owner token to the content creator of the digital object and added to the content creator's digital wallet. The identifier 404 corresponding to the holder of the object owner token for the digital object may, thus, correspond to the cryptographic hash for the digital wallet of the holder of the object owner token. In some instances, if the smart contract designates the content creator's digital wallet as the recipient digital wallet for any financial distributions associated with the digital object, the identifier 404 may be the address of the content creator's digital wallet (e.g., the recipient digital wallet). In some instances, the identifier 404 may be a username of the holder of the object owner token or owner of the recipient digital wallet indicated in the smart contract. For instance, when a user creates an account with the digital object marketplace, the user may be required to provide a unique username and credentials that may be used to access the digital object marketplace. This username may be displayed as the identifier 404.

In addition to providing a descriptive title and description of the digital object, the digital object marketplace may present, via the landing page, one or more categories 406 (e.g., genres, tags, etc.) for the digital object. When a content creator submits a request to publish a digital object, the content creator may select one or more categories 406 for its digital object. These one or more categories 406 may be used to describe one or more characteristics of the digital object. Further, the one or more categories 406 may be used as keywords for the digital object. As an illustrative example, if a user of the digital object marketplace submits a query for “fantasy games,” the digital object marketplace may determine that the digital object illustrated in FIGS. 4A-4C is associated with the keyword “fantasy” and present digital objects (including the digital object illustrated in FIGS. 4A-4C) associated with this category to the user via the interface.

In an embodiment, when a user accesses the landing page for a digital object, the digital object marketplace may, dynamically and in real-time, determine whether the user has a license token for the digital object. As noted above, a user may be required to link its digital wallet to its user account with the digital account marketplace. The digital wallet may be made accessible via a browser extension application 412 executed when a user accesses a corresponding browser application 400 on their computing device. In an embodiment, when a user accesses the digital object marketplace utilizing its browser application 400, the digital object marketplace may attempt to access the browser extension application 412 for authentication of the user and to link the user's account within the digital object marketplace with its digital wallet. The identifier of the digital wallet may be presented on the landing page, such as through identifier 402. Further, once a link has been established to the digital wallet, the digital object marketplace, via the browser extension application 412, may determine whether the user's digital wallet includes a license token for the digital object. In some instances, the identifier 402 may be a username of the user. Similar to the holder of the object owner token or owner of the digital wallet designated as the recipient digital wallet in the smart contract associated with the digital object, when the user creates an account with the digital object marketplace, the user may be required to provide a unique username and credentials that may be used to access the digital object marketplace. This username may be displayed as the identifier 402.

As illustrated in FIG. 4A, the digital object marketplace has determined that the user does not have a license token for accessing the digital object via the interface 410. As a result, the interface 410 may only include a static image or other graphical representation of the digital object. The digital object marketplace may prevent the user from interacting with the digital object via the interface 410. For instance, the digital object marketplace may forego launching a media player or other executable program that may be used to interact with digital object. In addition to presenting a static image or graphical representation of the digital object, the digital object marketplace may present the user with a purchase button 408 through which the user may be presented with an option to purchase a license token for the digital object. As noted above, the digital object marketplace may present, via the purchase button 408, the price required to purchase a license token for the digital object. The price presented within the purchase button 408 may correspond to the purchase price defined by the content creator and mapped to the smart contract for the digital object.

The purchase price presented via the purchase button 408 may be denoted using units of a cryptocurrency associated with the decentralized distributed ledger utilized by the digital object marketplace. As an illustrative example, the digital object marketplace may prompt a content creator to specify an amount of ether, or ETH (if the decentralized distributed ledger is implemented using the Ethereum blockchain), required to purchase a license token for the digital object. The amount of ETH specified by the content creator may be displayed within the purchase button 408 (e.g., 0.0015 ETH, as illustrated in FIG. 4A). The digital object marketplace can allow a content creator to define the price for the digital object using a fiat currency. If the content creator defines the price for the digital object using a fiat currency, the digital object marketplace may automatically convert the specified fiat currency amounts into corresponding units of a cryptocurrency associated with the decentralized distributed ledger in real-time and present this cryptocurrency price via the purchase button 408. For instance, when a user opts to purchase a license token for a digital object, the digital object marketplace may, in real-time, determine an exchange rate between the fiat currency used to define the price of the object license token and the cryptocurrency associated with the decentralized distributed ledger. The conversion may be presented to the user via the purchase button 408, which may allow the user to determine whether to proceed with the transaction.

If the user selects the purchase button 408, the digital object marketplace may proceed to process the user's request as illustrated in FIG. 4B. For instance, in response to selection of the purchase button 408, the digital object marketplace may update the landing page to present a processing button 414 in order to indicate that the purchase of the license token is being processed via the decentralized distributed ledger. The digital object marketplace may further transmit a transaction request to the browser extension application 412 associated with the user's digital wallet and linked to both the digital object marketplace and the decentralized distributed ledger. The transaction request may specify one or more parameters of the transaction (e.g., the purchase price, any applicable fees, address of smart contract through which the payment is to be distributed to the object owner or to a designated recipient digital wallet, etc.).

In response to receiving the transaction request, the browser extension application 412 may present an interface 416 through which the user may determine whether to proceed with the transaction to purchase the license token. The interface 416, as illustrated in FIG. 4B, may include a transfer panel 418 that indicates the address within the decentralized distributed ledger of the smart contract that is to distribute the payment and issue the license token to the user. Further, the interface 416 may include an interaction panel 420 that indicates that the transaction is a contract interaction with the smart contract and that the agreed upon purchase price is being transferred to this address. The interface 416 may further specify, in an additional fee panel 422, any applicable gas or other fees required by the distributed ledger to successfully conduct the transaction using the smart contract on the decentralized distributed ledger. The gas or other fees may be determined by the distributed network used to implement the decentralized distributed ledger. The total amount required for the transaction may be presented in a total transaction cost panel 424 of the interface 416. The user may use the interface 416 to determine whether to proceed with the transaction to purchase the license token.

If the user confirms, via the browser extension application 412, that it wishes to proceed with the transaction, the browser extension application may access the decentralized distributed ledger and process the transaction according to the agreed upon terms presented via the interface 416. The smart contract associated with the digital object and deployed to the decentralized distributed ledger may receive the transaction amount (e.g., purchase price) and the parameters of the purchase request (e.g., the owner token held by the content creator or independent developer of the digital object or the address of the designated recipient digital wallet, an identity token corresponding to the purchaser's digital wallet, etc.). The smart contract may distribute the payment according to the financial distribution schema specified therein. The payment may be processed from the user's digital wallet and the transaction may be recorded in the decentralized distributed ledger. Further, the smart contract may transfer a license token to the user's digital wallet to complete the transaction.

Once the user's digital wallet has been updated to include the license token for the digital object, the digital object marketplace may automatically, and in real-time, update the landing page for the digital object to allow the user to interact with the digital object, as illustrated in FIG. 4C. For instance, as illustrated in FIG. 4C, the digital object marketplace may update the processing button 414 to present an object interaction button 426 (e.g., “Play Game” button) that the user may select to submit a request to access the digital object via the interface 410. As noted above, the interface 410 may include an inline frame used to launch a media player through which the digital object may be accessed and utilized. The digital object may alternatively be executed within the interface 410 through an executable program, such as a JavaScript program using HTML technologies and rendering APIs, to execute the digital object within the browser application 400. The digital object, in some instances, may be presented through a client outside of the browser application 400. In response to user selection of the object interaction button 426, the digital object marketplace may launch the media player or the executable program within the interface 410 to enable the user to interact with the digital object. For instance, using the example illustrated in FIG. 4C, the user may play the “Boss Bridge” game via the interface 410.

In some instances, the digital object marketplace may allow the user, via the landing page of the digital object, to download the digital object to its computing device. For instance, in addition to updating the processing button 414 to present an object interaction button 426 that the user may select to access the digital object via the interface 410, the digital object marketplace may present a download button (not shown) that the user may select to request that the digital object be downloaded on to the user's computing device. This may allow the user to access the digital object offline.

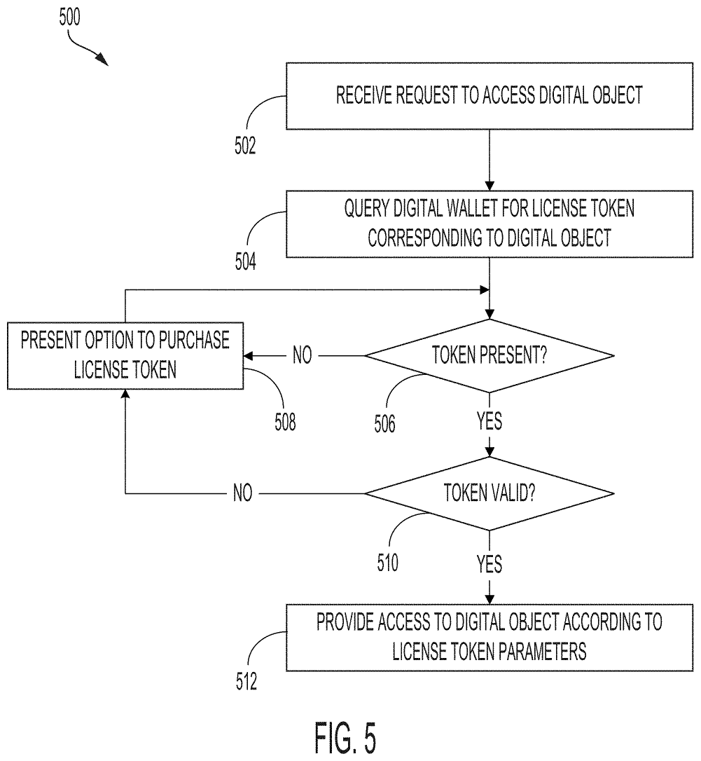

FIG. 5 shows an illustrative example of a process 500 for validating a license token for a digital object to determine whether to grant access to the digital object via the digital object marketplace in accordance with at least one embodiment. The process 500 may be performed by an object licensing system of the digital object marketplace, such as object licensing system 206 described above in connection with FIG. 2. Further, the process 500 may be performed in conjunction with a smart contract deployed in a decentralized distributed ledger and associated with the digital object for which the license token is being used to access.

At step 502, the object licensing system may receive a request from a user to access a digital object. For instance, when a user accesses a landing page for a digital object, such as through a website or web portal provided by the digital object marketplace, the user may automatically submit a request to access the digital object. In some instances, when a user accesses the landing page for the digital object, the user can manually submit a request to access the digital object. For example, through the landing page, the digital object marketplace can present one or more interface elements (e.g., GUI buttons, etc.) that the user may utilize to submit a request to access the digital object.

At step 504, the object licensing system may query the user's digital wallet for a license token corresponding to the digital object. For instance, the object licensing system, using an API, may access the browser extension application associated with the user's digital wallet to identify which tokens are available within the digital wallet. Thus, the object licensing system, by querying the user's digital wallet, may determine, at step 506, whether a license token for the digital object is present within the user's digital wallet.

If the object licensing system determines that the user does not have a license token for accessing the digital object, the object licensing system may, at step 508, present the user with an option to purchase a license token for the digital object. For instance, if the user does not have a license token for the digital object, the object licensing system may present, via the landing page for the digital object, a purchase option. As noted above, the purchase option may include an interactive element, such as GUI button that, if selected, may allow the user to submit a request to the object licensing system to purchase a license token for the digital object. The price presented within the purchase option may correspond to the purchase price defined by the content creator and mapped to the smart contract for the digital object. When the user purchases a license to the digital object via the object licensing system, the object licensing system may automatically transfer an object license token from its digital wallet to the digital wallet of the user. This transaction may be recorded in the decentralized distributed ledger. In some instances, the object license token can be generated at the point-of-sale (e.g., when the user submits a request to purchase a license to the digital object) by the smart contract and automatically transferred to the user's digital wallet. The payment submitted by the user may be transferred from the user's digital wallet to the content creator and any other content creators that may be entitled to financial distributions subject to a financial distribution schema defined in the smart contract.

In some examples, if the object licensing system determines that the user does not have a license token for accessing the digital object, the object licensing system may further determine whether there are any available license tokens available for the digital object that can be purchased by the user. In an embodiment, when a content creator publishes a digital object to the digital object marketplace, the content creator can define the number of license tokens for the digital object that may be generated and issued for the digital object, creating a level of scarcity for the digital object. Thus, if the object licensing system determines that the user does not have a license token for accessing the digital object, the object licensing system may determine whether the maximum number of license tokens have been minted and issued to other users of the digital object marketplace. If no license tokens are available, the user may be unable to purchase a license token and to access the digital object. In some instances, the user may be added to a waitlist, whereby the object licensing system may notify the user when a license token for the digital object becomes available for purchase (e.g., if another user lists a license token for sale via the digital object marketplace, the content creator requests creation of new license tokens for the digital object, etc.).

In an embodiment, if a license token for the digital object is present within the user's digital wallet, the object licensing system may, at step 510, determine whether the license token within the user's digital wallet is valid. For instance, a license token may be subject to an expiration as defined in the smart contract for the digital object. Thus, the object licensing system may evaluate the license token for the digital object to determine whether it has expired (e.g., the license token has been used a maximum allowable amount of times, an expiration date for the license token has passed, etc.). Further, in some instances, a license token may become invalid as a result of being associated with a user that is not authorized to access the digital object via the digital object marketplace. For instance, if a user is banned from the digital object marketplace, the object licensing system may denote the address of the user's digital wallet as being on a blacklist. By virtue of the user being added to this blacklist, any license tokens may no longer be valid for use within the digital object marketplace. The user, however, may still be able to transfer these license tokens to other users. Additionally, or alternatively, the object licensing system may suspend these license tokens until a resolution is achieved (e.g., transfer is made to a valid user, the content creator has indicated that access may be restored to the digital object, the user is removed from the blacklist, etc.). If the license token for the digital object is no longer valid, the object licensing system may, at step 508, present an option to the user to purchase a new license token (e.g., subject to availability and if the invalidity of the license token is not the result of the user being blacklisted, etc.).

If the license token present in the user's digital wallet is valid, the object licensing system, at step 512, may provide the user access to the digital object according to the license token parameters (e.g., any applicable policies defining a level of access to the digital object, etc.). For example, the object licensing system may update the landing page for the digital object to provide the user access to an interface through which the digital object may be accessed. Thus, if the license token present in the user's digital wallet is valid, the user may readily access the digital object via the website or web portal provided by the digital object marketplace.

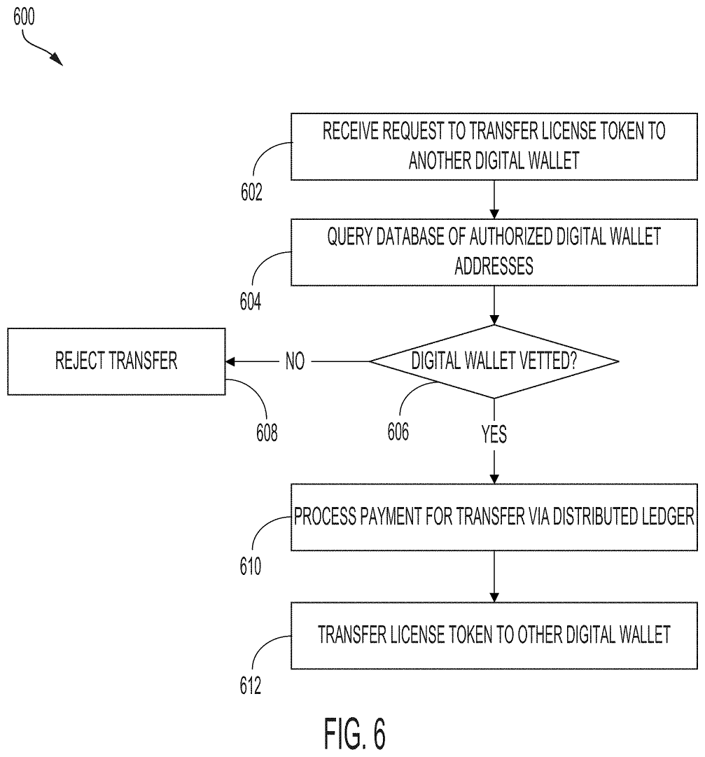

FIG. 6 shows an illustrative example of a process 600 for transferring a license token for a digital object from a first digital wallet to a second digital wallet in accordance with at least one embodiment. The process 600 may be performed by an object licensing system of the digital object marketplace, such as object licensing system 206 described above in connection with FIG. 2. Further, the process 600 may be performed in conjunction with a smart contract deployed in a decentralized distributed ledger and associated with the digital object for which the license token is being transferred to another user.

At step 602, the object licensing system may receive a request to transfer a license token for a digital object to another digital wallet associated with another user. The request may specify a cryptographic address of the recipient digital wallet that is to receive the license token for the digital object. Further, the request may indicate the cryptographic address of the digital wallet associated with the current owner of the license token. In addition to these addresses, the request may specify a payment amount for the transfer, which is to be distributed to the original owner of the license token and to any content creators associated with the digital object, subject to a distribution schema defined in the smart contract for the digital object.

At step 604, the object licensing system may query a database of authorized digital wallet addresses to determine whether the cryptographic address of the digital wallet associated with the intended recipient is present within the database. As noted above, the object licensing system maintains a database of authorized digital wallet addresses corresponding to users of the digital object marketplace. Each user of the digital object marketplace may be required to undergo an onboarding process, through which each user may be vetted by the digital object marketplace before being granted access to the digital object. As part of the onboarding process, the user may be required to link a digital wallet to the digital object marketplace via the object licensing system. As noted above, a digital wallet may be required for the management of license tokens, processing of payments for license tokens, and to receive automated payments associated with the purchase of license tokens by licensees and with financial distributions earned as a result of the sale of license tokens corresponding to digital media that includes digital objects subject to pre-defined financial distribution terms. The cryptographic address for the digital wallet may be added to the database of authorized digital wallet addresses. Thus, when a user attempts to purchase a license token or to transfer a license token to another user, the object licensing system may dynamically, and in real-time, determine whether the users involved have corresponding digital wallets that have been vetted by the digital object marketplace at step 606.

If the object licensing system determines that the digital wallet associated with the intended recipient has not been vetted, the object licensing system may, at step 608, reject the transfer of the license token to the intended digital wallet. For instance, if the intended recipient has not participated in an onboarding process in order to access the digital object marketplace, the intended recipient's digital wallet may not be included in the database of authorized digital wallet addresses maintained by the object licensing system. As another example, if the intended recipient is blacklisted from the digital object marketplace or has otherwise been identified as an entity that is not authorized to hold a license token for the digital object, the object licensing system can reject the requested transfer of the license token to the intended recipient. In some instances, a request to transfer a license token to another digital wallet may be automatically denied if it contravenes a transfer restriction by the content creator of the digital object associated with the license token.

If the intended recipient's digital wallet has been vetted, the object licensing system may, at step 610, process the payment from the intended recipient for transfer of the license token via the decentralized distributed ledger. For instance, the object licensing system may record the transaction in the decentralized distributed ledger. Further, the smart contract associated with the digital object may distribute the payment to the seller of the license token and to any content creators associated with the digital object subject to a distribution schema defined in the smart contract. At step 612, the object licensing system may transfer the license token to the intended recipient's digital wallet. This may allow the intended recipient to access the digital object via the digital object marketplace subject to any access control policies associated with the license token. Further, the original holder of the license token (e.g., the seller) may no longer have access to the digital object, as the original holder of the license token may no longer maintain the license token in its digital wallet.

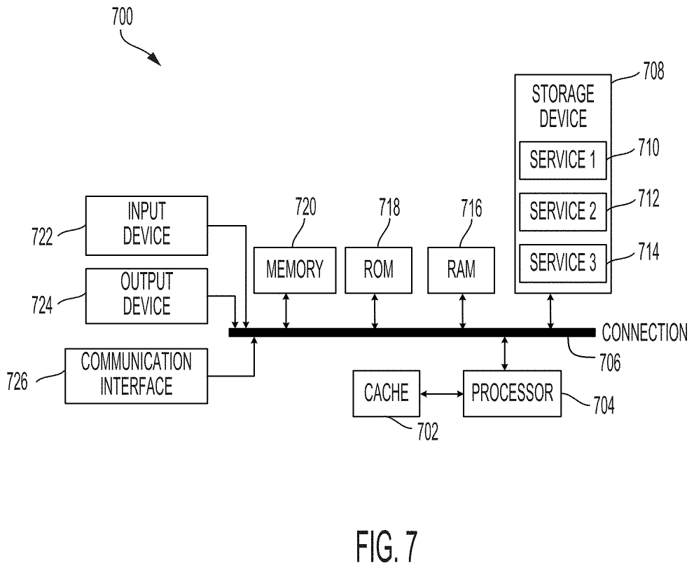

FIG. 7 illustrates a computing system architecture 700 including various components in electrical communication with each other using a connection 706, such as a bus, in accordance with some implementations. Example system architecture 700 includes a processing unit (CPU or processor) 704 and a system connection 706 that couples various system components including the system memory 720, such as ROM 718 and RAM 716, to the processor 704. The system architecture 700 can include a cache 702 of high-speed memory connected directly with, in close proximity to, or integrated as part of the processor 704. The system architecture 700 can copy data from the memory 720 and/or the storage device 708 to the cache 702 for quick access by the processor 704. In this way, the cache can provide a performance boost that avoids processor 704 delays while waiting for data. These and other modules can control or be configured to control the processor 704 to perform various actions.

Other system memory 720 may be available for use as well. The memory 720 can include multiple different types of memory with different performance characteristics. The processor 704 can include any general purpose processor and a hardware or software service, such as service 1 710, service 2 712, and service 3 714 stored in storage device 708, configured to control the processor 704 as well as a special-purpose processor where software instructions are incorporated into the actual processor design. The processor 704 may be a completely self-contained computing system, containing multiple cores or processors, a bus, memory controller, cache, etc. A multi-core processor may be symmetric or asymmetric.

To enable user interaction with the computing system architecture 700, an input device 722 can represent any number of input mechanisms, such as a microphone for speech, a touch-sensitive screen for gesture or graphical input, keyboard, mouse, motion input, speech and so forth.

An output device 724 can also be one or more of a number of output mechanisms known to those of skill in the art. In some instances, multimodal systems can enable a user to provide multiple types of input to communicate with the computing system architecture 700. The communications interface 726 can generally govern and manage the user input and system output. There is no restriction on operating on any particular hardware arrangement and therefore the basic features here may easily be substituted for improved hardware or firmware arrangements as they are developed.

Storage device 708 is a non-volatile memory and can be a hard disk or other types of computer readable media which can store data that are accessible by a computer, such as magnetic cassettes, flash memory cards, solid state memory devices, digital versatile disks, cartridges, RAMs 716, ROM 718, and hybrids thereof. In some aspects, storage device 708 can be implemented and reside in a cloud (in physical and/or virtual form), which may include one or more cloud components in one or more networks, distributed ledger-based computing in a cloud, and the like.

The storage device 708 can include services 710, 712, 714 for controlling the processor 704. Other hardware or software modules are contemplated. The storage device 708 can be connected to the system connection 706. In one aspect, a hardware module that performs a particular function can include the software component stored in a computer-readable medium in connection with the necessary hardware components, such as the processor 704, connection 706, output device 724, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks, distributed ledger-based computing in a cloud, and the like. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDNO modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term.

Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a first request to access a digital object, wherein the digital object is accessible via a remote interface;
querying a first digital wallet for a license token, wherein the license token grants access to the digital object via the remote interface, wherein the first digital wallet is associated with a distributed ledger, and wherein license tokens for the digital object are generated by a smart contract deployed in the distributed ledger;
prompting a user associated with the first digital wallet to purchase the license token, wherein the user is prompted as a result of a determination that the first digital wallet does not include the license token;
receiving a second request to purchase the license token;
transferring a payment from the first digital wallet to a second digital wallet associated with an owner of the digital object, wherein the payment is transferred by the smart contract, and wherein the payment is recorded in the distributed ledger;
providing the license token to the first digital wallet; and
granting access to the digital object via the remote interface, wherein access to the digital object is granted as a result of the first digital wallet including the license token.

2. The computer-implemented method of claim 1, further comprising:
determining that the license token is invalid; and
terminating access to the digital object via the remote interface.

3. The computer-implemented method of claim 1, further comprising querying a database of authorized digital wallet addresses to identify a cryptographic address of the first digital wallet, wherein the user is prompted to purchase the license token as a result of the cryptographic address being specified in the database.

4. The computer-implemented method of claim 1, further comprising:
receiving a new request to transfer the license token to another digital wallet;
distributing a new payment associated with the new request to the first digital wallet and to the second digital wallet, wherein the new payment is distributed using the smart contract, wherein the new payment is distributed according to a distribution schema defined in the smart contract;
transferring the license token to the other digital wallet, wherein when the license token is added to the other digital wallet, access to the digital object via the remote interface is granted to a user associated with the other digital wallet and terminated for the user associated with the first digital wallet.

5. The computer-implemented method of claim 1, wherein the payment is provided using a cryptocurrency, wherein the cryptocurrency corresponds to the distributed ledger.

6. The computer-implemented method of claim 1, further comprising:
determining that the first digital wallet is prohibited from holding the license token; and
destroying the license token, wherein when the license token is destroyed, access to the digital object is terminated.

7. The computer-implemented method of claim 1, wherein the first request is automatically generated in response to detecting that the user has attempted to access the digital object via the remote interface.

8. A system, comprising:
one or more processors; and
memory storing thereon instructions that, as a result of being executed by the one or more processors, cause the system to:
receive a first request to access a digital object, wherein the digital object is accessible via a remote interface;
query a first digital wallet for a license token, wherein the license token grants access to the digital object via the remote interface, wherein the first digital wallet is associated with a distributed ledger, and wherein license tokens for the digital object are generated by a smart contract deployed in the distributed ledger;
prompt a user associated with the first digital wallet to purchase the license token, wherein the user is prompted as a result of a determination that the first digital wallet does not include the license token;
receive a second request to purchase the license token;
transfer a payment from the first digital wallet to a second digital wallet associated with an owner of the digital object, wherein the payment is transferred by the smart contract, and wherein the payment is recorded in the distributed ledger;
provide the license token to the first digital wallet; and
grant access to the digital object via the remote interface, wherein access to the digital object is granted as a result of the first digital wallet including the license token.

9. The system of claim 8, wherein the instructions further cause the system to:
determine that the license token is invalid; and
terminate access to the digital object via the remote interface.

10. The system of claim 8, wherein the instructions further cause the system to query a database of authorized digital wallet addresses to identify a cryptographic address of the first digital wallet, wherein the user is prompted to purchase the license token as a result of the cryptographic address being specified in the database.

11. The system of claim 8, wherein the instructions further cause the system to:
receive a new request to transfer the license token to another digital wallet;
distribute a new payment associated with the new request to the first digital wallet and to the second digital wallet, wherein the new payment is distributed using the smart contract, wherein the new payment is distributed according to a distribution schema defined in the smart contract;
transfer the license token to the other digital wallet, wherein when the license token is added to the other digital wallet, access to the digital object via the remote interface is granted to a user associated with the other digital wallet and terminated for the user associated with the first digital wallet.

12. The system of claim 8, wherein the payment is provided using a cryptocurrency, wherein the cryptocurrency corresponds to the distributed ledger.

13. The system of claim 8, wherein the instructions further cause the system to:
determine that the first digital wallet is prohibited from holding the license token; and
destroy the license token, wherein when the license token is destroyed, access to the digital object is terminated.

14. The system of claim 8, wherein the first request is automatically generated in response to detecting that the user has attempted to access the digital object via the remote interface.

15. A non-transitory, computer-readable storage medium storing thereon executable instructions that, as a result of being executed by one or more processors of a computer system, cause the computer system to:
receive a first request to access a digital object, wherein the digital object is accessible via a remote interface;
query a first digital wallet for a license token, wherein the license token grants access to the digital object via the remote interface, wherein the first digital wallet is associated with a distributed ledger, and wherein license tokens for the digital object are generated by a smart contract deployed in the distributed ledger;
prompt a user associated with the first digital wallet to purchase the license token, wherein the user is prompted as a result of a determination that the first digital wallet does not include the license token;
receive a second request to purchase the license token;
transfer a payment from the first digital wallet to a second digital wallet associated with an owner of the digital object, wherein the payment is transferred by the smart contract, and wherein the payment is recorded in the distributed ledger;
provide the license token to the first digital wallet; and
grant access to the digital object via the remote interface, wherein access to the digital object is granted as a result of the first digital wallet including the license token.

16. The non-transitory, computer-readable storage medium of claim 15, wherein the executable instructions further cause the computer system to:
determine that the license token is invalid; and
terminate access to the digital object via the remote interface.

17. The non-transitory, computer-readable storage medium of claim 15, wherein the executable instructions further cause the computer system to query a database of authorized digital wallet addresses to identify a cryptographic address of the first digital wallet, wherein the user is prompted to purchase the license token as a result of the cryptographic address being specified in the database.

18. The non-transitory, computer-readable storage medium of claim 15, wherein the executable instructions further cause the computer system to:
receive a new request to transfer the license token to another digital wallet;
distribute a new payment associated with the new request to the first digital wallet and to the second digital wallet, wherein the new payment is distributed using the smart contract, wherein the new payment is distributed according to a distribution schema defined in the smart contract;
transfer the license token to the other digital wallet, wherein when the license token is added to the other digital wallet, access to the digital object via the remote interface is granted to a user associated with the other digital wallet and terminated for the user associated with the first digital wallet.

19. The non-transitory, computer-readable storage medium of claim 15, wherein the payment is provided using a cryptocurrency, wherein the cryptocurrency corresponds to the distributed ledger.

20. The non-transitory, computer-readable storage medium of claim 15, wherein the executable instructions further cause the computer system to:
determine that the first digital wallet is prohibited from holding the license token; and
destroy the license token, wherein when the license token is destroyed, access to the digital object is terminated.

21. The non-transitory, computer-readable storage medium of claim 15, wherein the first request is automatically generated in response to detecting that the user has attempted to access the digital object via the remote interface.
